(19) United States
(12) Patent Application Publication
(10) Pub. No.: US 2026/0281983 A1
(43) Pub. Date: Sep. 17, 2026

(54) METHOD AND SIGNALING FOR ENABLING ADAPTATION OF SUBBANDS

(71) Applicant: CENTRE OF EXCELLENCE IN WIRELESS TECHNOLOGY, Chennai Tamil Nadu (IN)

(72) Inventors: Deepak Padmanabhan MAYAKUMARI, Chennai Tamil Nadu (IN); Priyanka DEY, Chennai Tamil Nadu (IN); Jeniston Deviraj Klutto MILLETH, Chennai Tamil Nadu (IN); Bhaskar RAMAMURTHI, Chennai Tamil Nadu (IN)

(73) Assignee: INDIAN INSTITUTE OF TECHNOLOGY MADRAS (IIT MADRAS), Chennai Tamil Nadu (IN)

(21) Appl. No.: 19/168,861

(22) PCT Filed: Apr. 2, 2024
(86) PCT No.: PCT/IN2024/050351

§ 371 Date: Sep. 25, 2025

(30) Foreign Application Priority Data
Apr. 3, 2023 (IN) 202341025260

(51) Int. Cl. H04W 72/0446; H04L 5/14; H04W 72/231; H04W 72/232

(52) U.S. Cl. CPC H04W 72/0446; H04L 5/14; H04W 72/231; H04W 72/232

(57) ABSTRACT

A method of signaling in a cellular network includes receiving, by a first node, at least one first configuration and at least one second configuration from at least one second node. The at least one first configuration comprises at least one first resource and type of operation of the at least one first resource, and the at least one second configuration comprises at least one sub-band, type of operation of at least one sub-band and at least one time resource in which the at least one sub-band is active. The first node determines at least one second resource and type of operation of the at least one second resource for at least one time resource. The first node performs the type of operation of the at least one second resource in the at least one second resource and the at least one time resource.

### FIELD OF THE INVENTION

The present invention relates to signaling technique for telecommunication networks, and more particularly to signaling in sub-band full duplexing communication.

### BACKGROUND OF THE INVENTION

In sub band full duplexing (SBFD) communication, a node can simultaneously perform downlink (DL) and uplink (UL) operations in different subbands within a same carrier frequency. A subband is a set of frequency resources within the same carrier frequency. The frequency resource within the same carrier frequency can be of fully overlapping, partially overlapping, or non-overlapping subbands. FIG. 1 cumulatively illustrates different types of SBFD subbands. FIG. 1a illustrates non-overlapping subbands, FIG. 1b illustrates partially overlapping subbands, and FIG. 1c illustrates fully overlapping subbands.

One major drawback of SBFD operation is self-interference (SI) caused by simultaneous DL and UL transmission and reception, respectively in a node. In case of SBFD with non-overlapping subbands, guard bands can be used between the frequency resources for DL and UL operation to minimize the impact of SI.

In fifth generation new radio (5G-NR) specification, a carrier can be configured for either DL or UL operations at a time in case of time division duplex (TDD) operation. In SBFD, subbands can be configured within the carrier and subbands can be simultaneously configured for different set of operations (E.g., DL and UL). Below explained scenarios may arise within a carrier due to frequency domain configuration for SBFD.

In one scenario i.e. DUD scenario, UL subband may exist within same carrier configured for DL for a time resource. In this scenario, the UL subband is sandwiched between two DL subbands. For example, carrier is configured for DL operation in a time resource using the techniques defined in 5G-NR. Simultaneous UL operation can be enabled within the same carrier by configuring a UL subband, for UL operation, and activating it in the time resource. In another example, the base station (gNB) can configure a UL subband within the same carrier, configured for DL operation using methods defined in 5G-NR, and can schedule UL transmission from UE in the configured UL subband. Therefore, the gNB will simultaneously perform DL transmission to a UE in the DL subband and UL reception from another UE in the UL subband within the same carrier.

In another scenario i.e. UDU scenario, the DL subband may exist within the same carrier configured for UL for a time resource. In this scenario, the DL subband is sandwiched between two UL subbands. For example, the carrier is configured for UL operation in a time resource using one of the methods defined in 5G-NR specification. Now, the simultaneous DL operation can be enabled within the same carrier by configuring a DL subband, for DL operation, and activating it in the time resource. In another example, the gNB can configure a DL subband within the same carrier, configured for UL operation using one of the methods defined in 5G-NR specification, and can schedule DL transmission to a UE in the configured DL subband. Therefore, the gNB can simultaneously perform UL reception in the UL subband and DL transmission to another UE in DL subband.

Further, the SBFD operation can be enabled for a set of time resources, referred as SBFD active time resources in this document, in which the subband is active. The SBFD active time resource can be contiguous or non-contiguous. The time resource granularity can be at symbol level, at slot level or resource type within a slot. FIG. 2 illustrates a notion of UL subband and SBFD active time resource. A resource grid consisting of 8 resource blocks (RBs) and 7 symbols within a carrier is shown. The carrier is configured to perform DL operation using conventional methods. In SBFD, the portion from RB1 to RB4 can be configured as UL subband and UL operation can be configured within the subband. It can be seen that the UL subband is active only from symbols 1 to symbol 5 and is denoted as SBFD active time resources. Further, the information about subbands and SBFD active time resources at a node is essential at other nodes in the network for adapting its operations to tackle various issues arising due to SBFD.

In SBFD, the node should be able to perform simultaneous DL/UL operation and a provision must exist to schedule simultaneous DL/UL i.e. a gNB in SBFD should be able to schedule DL reception to a UE and simultaneously schedule UL transmission from another UE. However, in existing 5G-NR specification, the gNB has various limitations in scheduling simultaneous UL/DL. In 5G-NR, the UE is semi-statically indicated about DL/UL/F configuration for a time resource using time division duplexing (TDD) configurations (e.g., TDD_UL_DL_Config_common and TDD_UL_DL_Config_dedicated in 5G-NR). Further, the time resources configured as F can be dynamically indicated as DL/UL using slot format indicator (SFI) in downlink control information (DCI). However, in 5G-NR, the configuration provided by common TDD configuration i.e., TDD_UL_DL_Config_common is common for all UEs in a cell and DL/UL configuration provided for a time resource cannot be overwritten using dedicated TDD configuration i.e., TDD_UL_DL_Config_dedicated or SFI format. Therefore, the SBFD operation will be limited to the F symbols configured by TDD_UL_DL_Config_common. If a slot is indicated as DL by TDD_UL_DL_Config_common, all the UEs in the cell will be DL and the gNB cannot schedule UL transmission from the UEs in that slot. Therefore, the gNB cannot operate in SBFD in the slot. Similarly, in 5G-NR specification, the SFI cannot override the DL/UL configuration provided by TDD_UL_DL_Config_dedicated. Hence, the gNB cannot enable SBFD dynamically at a UE if a resource is semi-statically configured as DL/UL.

Similarly, in cellular technologies, a large bandwidth (BW) is needed to support a variety of services and satisfy the increasing demand of data rates. However, the use of larger BW increases the power consumption at the gNB, thereby increasing the operational cost of the network. Therefore, flexible adaptation of the channel BW is required to provide energy saving at the gNB. The gNB can turn off transmission/reception in certain frequency range (otherwise subband) to reduce energy consumption. The BW can be adapted based on many parameters. For example, network load, user equipment (UE) uplink-downlink (UL-DL) traffic, etc. However, the adaptation of bandwidth creates issues similar to SBFD, as mentioned above. For example, UE can be semi-statically configured by gNB for periodic receptions within certain frequency resources. Adapting the BW dynamically by the gNB can cause deactivation of certain portion of the frequency resources configured to the UE, that leads to unnecessary monitoring by the UE.

Therefore, there arises a need of a method of configuring subbands and SBFD active time resources, and method for exchanging parameters of SBFD operation between nodes in the network, and the behaviour of the node in response to receiving parameters of SBFD.

### OBJECTS OF THE INVENTION

A general objective of the present invention is to overcome various limitations imposed by 5G-NR specification in enabling SBFD and enable SBFD in a network in a flexible manner.

Another objective of the invention is to provide configurations related to SBFD to other nodes in the network.

Another objective of the invention is to define behavior and procedures at various nodes in the network in response to SBFD configuration.

Another objective of the invention is to provide signaling of information about the BW adaptation at one node to other nodes in the network.

### SUMMARY OF THE INVENTION

The summary is provided to introduce aspects related to a method and signaling for enabling adaptation of subbands, and the aspects are further described below in the detailed description. This summary is not intended to identify essential features of the claimed subject matter nor is it intended for use in determining or limiting the scope of the claimed subject matter.

In one embodiment, a method of signaling in a cellular network is described. The method comprises receiving, by at least one first node, at least one first configuration and at least one second configuration from at least one second node. The at least one first configuration comprises at least one first resource and type of operation of the at least one first resource, and the at least one second configuration comprises at least one sub-band, type of operation of at least one sub-band and at least one time resource in which the at least one sub-band is active. The method further comprises determining, by the at least one first node, at least one second resource and type of operation of the at least one second resource for at least one time resource. The at least one second resource and the type of operation of the at least one second resource is determined using at least one of the at least one first configuration and the at least one second configuration. The method further comprises performing, by the at least one first node, the type of operation of the at least one second resource in the at least one second resource and the at least one time resource.

In one aspect, the type of operation is one of a Downlink (DL) operation and an Uplink (UL) operation.

In one aspect, the determining comprises determining at least one first resource comprising at least one time resource.

In one aspect, the receiving by the at least one first node is performed based on at least one of a common signaling and a dedicated signaling from at least one second node.

In one aspect, at least one of the at least one first configuration and the at least one second configuration is received using at least one of Radio Resource Control (RRC) message, Medium Access Control-Control Element (MAC-CE) message, and at least one Downlink Control Information (DCI).

In one aspect, the DCI comprises at least one Slot Format Indicator (SFI).

In one aspect, determining the type of operation of the at least one second resource as the type of operation of the at least one first resource when at least one of
the at least one first configuration is received with a priority flag, and
the at least one second configuration is received without priority flag.

In one aspect, determining the type of operation of the at least one second resource as the type of operation of at least one sub-band when at least one of
the at least one second configuration is received with a priority flag,
the at least one second configuration is received dynamically,
the at least one second configuration is received using a DCI format dedicated for configuring at least one second configuration, and
the at least one second configuration is received using a DCI format containing at least one Slot Format Indicator (SFI) dedicated for configuring at least one second configuration.

In one aspect, the priority flag indicates one of
priority of at least one second configuration over at least one first configuration, and
type of operation of at least one sub-band in which the at least one first node has to operate.

In one aspect, determining the type of operation of the at least one second resource comprises one of
determining type of operation of at least one sub-band as downlink (DL) sub-band and determining the type of operation of the at least one second resource as DL, and
determining type of operation of at least one sub-band as uplink (UL) sub-band and determining the type of operation of the at least one second resource as UL.

In one aspect, determining the at least one second resource comprises one of
determining a non-overlapping portion of at least one first resource and at least one sub-band as at least one second resource, and
determining an overlapping portion of at least one first resource and at least one sub-band as at least one second resource.

In one aspect, determining the non-overlapping portion of at least one first resource and at least one sub-band as at least one second resource comprises one of
determining at least one first operation is reception of at least one Channel State Information-Reference Signal (CSI-RS),
determining type of operation of the at least one first resource as DL and type of operation of at least one sub-band as UL, and
determining type of operation of the at least one first resource as UL and type of operation of at least one sub-band as DL.

In one aspect, determining the overlapping portion of the at least one first resource and the at least one sub-band as the at least one second resource comprises one of
determining a type of operation of the at least one first resource as DL and type of operation of at least one sub-band as DL, and
determining a type of operation of the at least one first resource as UL and a type of operation of at least one sub-band as UL.

In one aspect, the method comprises receiving, by the at least one second node, an indication of at least one second resource and type of operation of the at least one second resource.

In one aspect, the receiving is using at least one of dedicated signaling and Downlink Control Information (DCI).

In one aspect, the at least one time resource comprises at least one of an index, starting time, duration and periodicity.

In one aspect, the starting time comprises at least one of slot offset, symbol offset and number of time units.

In one aspect, the duration comprises at least one of number of slots, number of symbols and number of time units.

In one aspect, the starting time is applied from start of time unit of receiving.

In one aspect, the starting time is applied from start of time unit immediately after time unit of receiving.

In one aspect, the starting time of at least one second configuration is predefined.

In one aspect, receiving is at least one of periodic, semi-persistent, and aperiodic.

In one aspect, the receiving comprises
receiving a plurality of second configuration using a Radio Resource Control (RRC) message, and
receiving at least one of Medium Access Control-Control Element (MAC-CE) message and Downlink Control Information (DCI) activating the at least one second configuration.

In one aspect, the activating comprises an index of at least one second configuration.

In one aspect, the method further comprises
receiving, by the at least one first node, a deactivation command, and
deactivating, by the at least one first node, the at least one second configuration.

In one aspect, the at least one time resource is indicated for a plurality of slots, and wherein the plurality of slots is contiguous and marked by starting slot index and number of slots.

In one aspect, the at least one time resource comprises symbol type in a time unit.

In one aspect, the symbol type is at least one of DL symbols, UL symbols and flexible symbols.

In one aspect, the at least one time resource is indicated using a bitmap.

In one aspect, the receiving is one of cell-specific signal, node-specific signal, and group of nodes specific signal.

In one aspect, the at least one sub-band comprises a starting frequency location and a bandwidth of the at least one sub-band.

In one aspect, the bandwidth of the at least one sub-band is indicated by a number of Resource Block (RB).

In one aspect, the starting frequency location is indicated by an offset from a reference point, and wherein the reference point is one of
an RB in a common resource grid,
starting frequency resource from a plurality of frequency resources configured to the at least one second node for monitoring control information, and
starting frequency resource of the BWP configured to the at least one second node.

In one aspect, the method comprises determining, by the at least one first node, the active BWP based on the at least one first configuration and the at least one second configuration.

In one aspect, the determining comprises
determining type of operation of the at least one first resource same as a type of operation of the at least one sub-band, and
determining an overlapping portion of the at least one first resource and the at least one sub-band as active BWP.

In one aspect, the determining comprises
determining a type of operation of the at least one first resource different from type of operation of the at least one sub-band, and
determining an non-overlapping portion of at least one first resource and the at least one sub-band as active BWP.

In one embodiment, a method of signaling in a cellular network is described. The method comprises signaling, by at least one first node, at least one first configuration comprising at least one sub-band, type of operation of the at least one sub-band, and at least one time resource in which the at least one sub-band is active, wherein the type of operation of at least one sub-band comprises one of DL sub-band and UL sub-band. The method further comprises performing, by the at least one first node, in the at least one time resource at least one DL operation in at least one first frequency resource in DL sub-band, and at least one UL operation in at least one second frequency resource in UL sub-band.

In one aspect, the signaling comprises determining at least one sub-band and at least one time resource in which the at least one sub-band is active.

In one aspect, the at least one first configuration comprises at least one of Time Division Duplexing (TDD) configuration and Bandwidth Part (BWP) configuration.

In one aspect, the signaling is done as one of common signaling and dedicated signaling.

In one aspect, the signaling uses at least one of Radio Resource Control (RRC) message, MAC-CE message, and downlink control information (DCI).

In one aspect, the DCI format comprises a Slot Format Indicator (SFI).

In one aspect, the method comprises performing at least one of
scheduling, by the at least one first node, at least one DL operation to at least one second node in at least one time resource and at least one first frequency resource, and
scheduling, by the at least one first node, at least one UL operation to at least one third node in at least one time resource and at least one second frequency resource.

In one aspect, the scheduling comprises a priority flag.

In one aspect, the scheduling is done using Downlink Control Information (DCI).

In one aspect, the at least one first configuration comprises a priority flag.

In one aspect, the priority flag indicates one of
a priority of at least one first configuration over other configurations,
a priority of a subband from the at least one subband, and
a subband from at least one sub-band in which the at least one second node has to operate.

In one aspect, the signaling is one of periodic, semi-persistent and aperiodic.

In one aspect, the at least one time resource comprises at least one of an index, starting time, duration, and periodicity.

In one aspect, the starting time comprises at least one of slot offset, symbol offset and number of time units.

In one aspect, the duration comprises at least one of number of slots, number of symbols, and number of time units.

In one aspect, the starting time is applied from start of a time unit, and wherein the time unit is one of
time unit of signaling at least one first configuration, and
time unit immediately after signaling at least one first configuration.

In one aspect, the signaling comprises
signaling a plurality of at least one first configurations, and
activating at least one first configuration from the plurality of at least one first configurations.

In one aspect, the activating comprises indicating an index of at least one first configuration.

In one aspect, the method comprises signaling a deactivation command and deactivating the at least one first configuration.

In one aspect, the at least one time resource comprises a plurality of time units in a time duration.

In one aspect, the plurality of time units is contiguous and marked by starting slot index and number of slots.

In one aspect, the at least one time resource comprises symbol type within a time unit.

In one aspect, the symbol type is at least one of DL symbols, UL symbols, and flexible symbols.

In one aspect, the at least one time resource is indicated using a bitmap.

In one aspect, the at least one sub-band comprises a starting frequency location and a bandwidth of the at least one sub-band.

In one aspect, a bandwidth of the at least one sub-band is indicated by number of Resource Block (RB).

In one aspect, the starting frequency location is indicated by an offset from a reference point, and wherein the reference point is one of
a RB in a common resource grid,
starting frequency resource from a plurality of frequency resources configured to the at least one second node for monitoring control information, and
starting frequency resource of the BWP configured to the at least one second node.

In one aspect, the signaling is one of cell-specific signal, node-specific signal, and group of nodes specific signal.

### BRIEF DESCRIPTION OF THE DRAWINGS

FIG. 1a illustrates non-overlapping subbands, FIG. 1b illustrates partially overlapping subbands, and FIG. 1c illustrates fully overlapping subbands.

FIG. 2 illustrates a notion of UL subband and SBFD active time resource.

FIG. 3 illustrates conflicts among SBFD operation and conventional configurations, in accordance with an embodiment of the present invention.

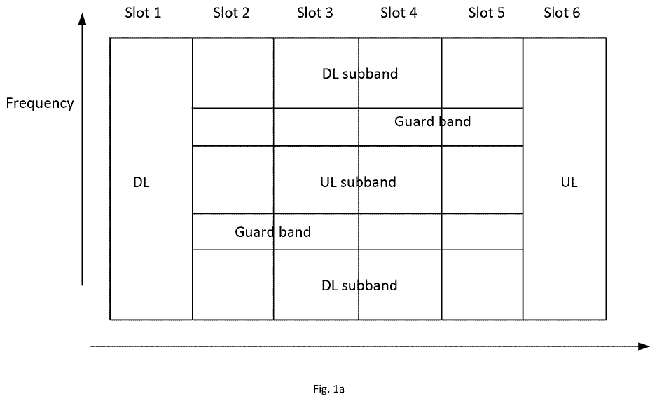

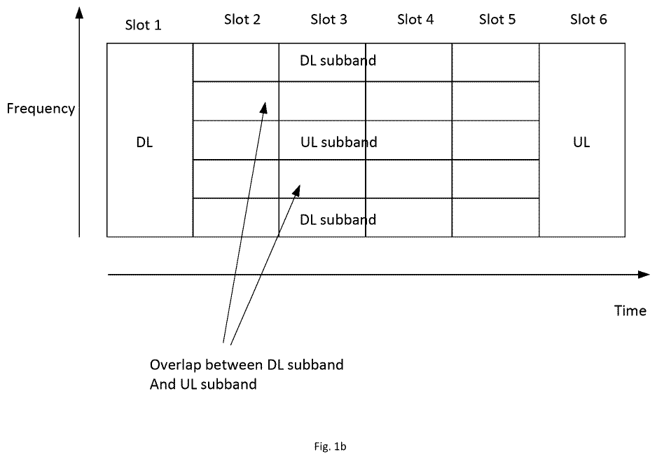

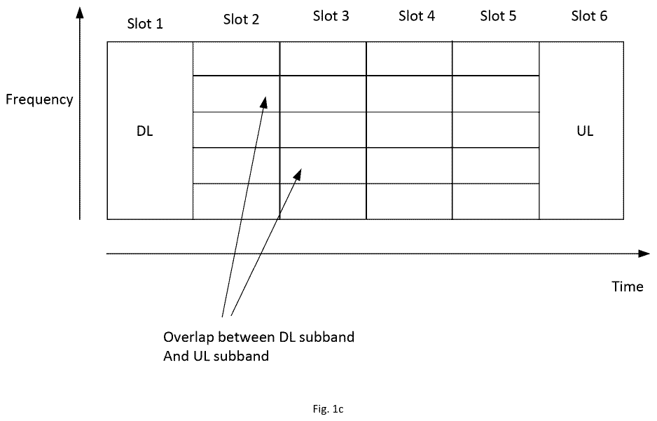

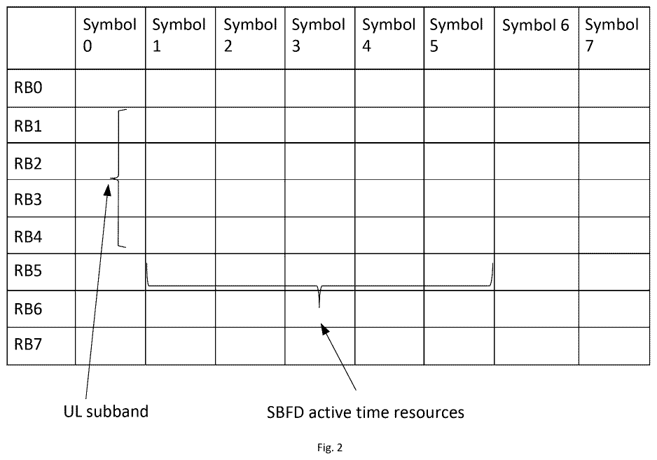

### DETAILED DESCRIPTION OF THE INVENTION

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. This disclosure may however, be embodied in many different forms and should not be construed as limited to the embodiments set forth herein. These embodiments are provided so that this disclosure will be thorough and complete and will fully convey the scope of the disclosure to those of ordinary skill in the art. Moreover, all statements herein reciting embodiments of the disclosure, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Present invention describes a method and signaling for enabling adaptation of subbands. Even though the proposed techniques are explained in terms of SBFD, they are equally applicable for any scenario involving adaptation of resources.

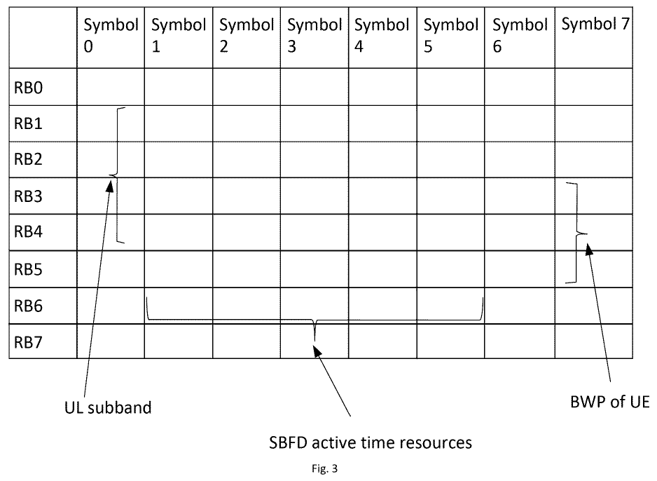

The UEs in a network, with SBFD enabled gNBs, can be classified into three types. A type 1 UE is an SBFD capable UE operating inside an indicated subband indicated. FIG. 3 illustrates conflicts among SBFD operation and conventional configurations, in accordance with an embodiment of the present invention. In FIG. 3, RB3-RB5 denote DL BWP i.e. the set of frequency resources configured to the UE by the gNB for DL operation. The type 1 UE can be indicated about RB3 and RB4 as UL subband and can be allowed to schedule data transmission in resources of UL subband. The type 1 UE performs a configured operation in the scheduled resources. Further, a type 2 UE is a SBFD capable UE operating outside an indicated subband. In FIG. 3, RB3-RB5 denote DL BWP i.e. the set of frequency resources configured to the UE by the gNB for DL operation. The type 2 UE schedules data reception in RB3-RB5 in symbol 4 and is indicated about RB3-RB4 as UL subband. In such case, the UE skip/adapt data reception in RBs overlapping with the subband such as in RB3 and RB4. Further, a type 3 is a UE which cannot receive subband indication from the gNB, for example a legacy UE.

In SBFD, the node should be able to perform simultaneous DL/UL operation and there should be provision to schedule simultaneous DL/UL. For example, a gNB in SBFD should be able to schedule DL reception to a UE and UL Tx from another UE simultaneously. However, in existing 5G-NR specification, the gNB has various limitations in scheduling simultaneous UL/DL.

Present invention provides methods for overcoming the limitations of gNBs in scheduling simultaneous UL/DL and enabling SBFD operation in an efficient manner.

In one embodiment, the configuration for SBFD operation in a time resource is provided using dedicated/group common signaling to a UE and it overrides other configurations given to the UE. The overriding can be for the subband indicated or for the entire BWP. Further, the overriding can be for the time resources indicated as SBFD active time resources.

In one embodiment, the configuration can be provided in DL control channel. For example, slot format indicator (SFI) formats which are reserved in 5G-NR can be used to provide DL/UL configuration in the SBFD active time resources and it overrides the DL/UL configuration provided by the time division duplexing (TDD) configurations. Further, the overriding can be for the set of frequency resources within the BWP which overlaps with the subband indicated. The advantage of configuring using reserved formats is that the existing specification will not be changed i.e. the dedicated TDD configuration and the SFI formats, in 5G-NR specification, cannot override configuration provided by common TDD configuration. For example, in FIG. 3, if symbol 3 is configured as DL by the common and/or dedicated TDD configuration then the entire BWP (i.e., RB3-RB5) will be DL in symbol 3. In present embodiment, if the symbol 3 is indicated as UL by DCI format 2_0 using SFI format with index greater than 55, then the RB3 and RB4 (shown to be overlapping with UL subband in FIG. 3) will be converted to UL in symbol 3. If the DCI format 2_0 indicates UL using a SFI format with index less than 56, then it cannot override configuration provided by common and/or dedicated TDD (i.e., same as the legacy mechanism).

In another embodiment, scheduling of data/control/reference signals can be done irrespective of the TDD configuration, and the scheduling overrides the DL/UL configuration provided. For example, if a set of symbols of the slot is configured as DL to a UE by the common TDD configuration/dedicated TDD configuration/SFI and UL data is scheduled in the set of symbols of the slot by dynamic scheduling then UE performs transmission of data in UL in the set of symbols of the slot.

In one embodiment, the dynamic scheduling can be using new DCI format for scheduling SBFD operation or using a DCI format, defined in 5G-NR, with an extra field to indicate priority/overriding over TDD/SFI configurations. For example, in FIG. 3, if symbol 3-6 are configured as DL for the UE using common and/or dedicated TDD configuration then, based on conventional mechanism, the entire BWP (i.e., RB3-RB5) will be DL for the UE in symbols 3-6 and the UE will not expect any scheduling for UL in the BWP in symbols 3-6. In the proposed method, if the UE receives a DCI format 0_1, defined in 5G-NR for UL data scheduling, with priority flag that schedules UL data spanning over RB3-RB4 and symbols 3-4, then the UE transmits UL data even if the set of symbols are configured as DL by TDD configurations.

In another embodiment, if the dynamic scheduling is for the resource indicated for SBFD operation, such as SBFD active time resource and subbands, scheduling overrides the legacy configurations/scheduling. For example, in FIG. 3, if symbol 3-6 are configured as DL for the UE using common and/or dedicated TDD configuration then, based on the method specified in 5G-NR, the entire BWP (i.e., RB3-RB5) will be DL for the UE in symbols 3-6 and the UE will not expect any scheduling for UL in the BWP in symbols 3-6. In the proposed method, if the UE is indicated RB1 to RB4 as UL subband and symbol 3 to symbol 5 as SBFD active time resource, and if the UE receives a DCI format scheduling UL data transmission spanning over RB3-RB4 and symbols 3-4, then the UE transmits data even if the set of symbols are configured as DL by TDD configurations.

In case of SBFD, the type 2 UEs can be informed about the subband for SBFD operation and SBFD active time resources so that the UE can skip/adapt the operations configured within the subband in the SBFD active time resources. For example, if a type 2 UE is configured for CSI-RS reception in the bandwidth part, which is overlapping with UL subband, in slot n. If SBFD is enabled in slot n, then gNB will perform UL operation in the UL subband, including the portion overlapping with BWP of UE. Therefore, there will not be any CSI-RS transmission to the UE, at least in the overlapping portion. The UE can be informed about the UL subband and SBFD operation in slot n, so that the UE can skip monitoring for CSI-RS in slot n, at least in the portion of BWP overlapping with UL subband.

The gNB can activate SBFD operation periodically, semi-persistently or aperiodically. Therefore, the SBFD active time resource can be periodic, semi-persistent and aperiodic. The type can be configured by gNB along with indication of SBFD active time resource.

In case of periodic, the indication of SBFD active time resource is semi-static using RRC and it comprises starting time, duration, and periodicity. The starting time can be in terms of slot offset and/or symbol offset or in terms of number of time units. In one method, the offset is applied immediately after configuring. For example, in slot n, gNB indicate SBFD active time resource as (type=periodic, slot offset=2, symbol offset=5, duration=6, periodicity=10), then SBFD is active in symbols 5-11 in slot n+2, slot n+2+10, slot n+2+20, etc. In another method, the offset is applied starting from the slot which is immediately after the slot of reception of indication. In another method, the reference point for applying the slot offset is defined in the standard in terms of number of slots or time units.

In case of semi-persistent, gNB semi-statically configures using RRC one or more SBFD active time resources. The MAC-CE activates/deactivates one or more SBFD active time resource. Once activated, the SBFD will be enabled periodically as per the selected configuration until deactivation. In one method, the SBFD active time resource provided by RRC comprises {index, type, slot offset, symbol offset, duration, and periodicity}. The duration can be in terms of number of slots, number of symbols or number of time units. The activation/deactivation command in MAC-CE select one index. Table 1 provided below illustrates a sample configuration provided by RRC. If MAC-CE activation command in slot n indicates index-3, that corresponds to (type=semi-persistent, slot offset=2, symbol offset=5, duration=6, periodicity=10), then SBFD is active in symbols 5-11 in slot n+2, slot n+2+10, slot n+2+20, etc.

TABLE 1
Configuration of SBFD active time resource
which is activated using MAC-CE

| Configura- | | |
|---|---|---|
| tion index | Type | Parameters |
| 1 | Semi- | slot offset = 5, symbol offset = 0, duration = |
| | persistent | 12, periodicity = 5 |
| 2 | Semi- | slot offset = 1, symbol offset = 5, duration = |
| | persistent | 8, periodicity = 2 |
| 3 | Semi- | slot offset = 2, symbol offset = 5, duration = |
| | persistent | 6, periodicity = 10 |
| 4 | Semi- | slot offset = 2, symbol offset = 2, duration = |
| | persistent | 20, periodicity = 20 |
| 5 | Semi- | slot offset = 3, symbol offset = 10, duration = |
| | persistent | 4, periodicity = 5 |

In another method, the MAC-CE selects multiple configurations which will be simultaneously active. For the e.g., above MAC-CE selects configuration indices 3 and 5 in slot n, so that SBFD will be active in symbols 5-11 in slot n+2 slot n+2+10, slot n+2+20, etc. and in symbols 10-14 in slot n+3, slot n+3+8, slot n+3+16, etc. In another method, the offset is applied starting from the slot which is immediately after the slot of reception of indication. In another method the reference point for applying the slot offset is defined in the standard in terms of number of slots or time units.

In case of aperiodic, the configuration comprises type, slot offset, symbol offset, and duration. The duration can be in terms of number of slots, number of symbols or number of time units. For example, in slot n, gNB indicate SBFD active time resource as (type=aperiodic, slot offset-2, symbol offset-5, duration-6), then SBFD is active in symbols 5-11 in slot n+2. In one method, the offset is applied starting from the slot which is immediately after the slot of reception of indication. In another method, the reference point for applying the slot offset is defined in the standard in terms of number of slots or time units.

The SBFD active time resources can be indicated for a plurality of slots. In one method, the plurality of slots can be marked to be contiguous by starting slot index and number of slots. In another method, the plurality of slots is number of slots between two SBFD active time resource indications. In another method, the plurality of slots is predefined in standards. For e.g., one indication will signal SBFD active time resources in a frame. E.g., an indication comprises {(slot index=1, symbol offset-2, duration=5), (slot index=2, symbol offset=5, duration=8), {(slot index-3, symbol offset-0, duration=10), (slot index-4, symbol offset=10, duration=3)} in slot n will indicate SBFD symbols in slot n+1 to slot n+4. In another method, an indication of SBFD active time resource comprises a time index, starting time resource and length of time resource. For example, indication comprising (slot n, s=12, L=2) implies in slot n SBFD is enabled in symbols 12 to 14. In another method, the indication comprises time index and an SLIV value, where the SLIV value point to a starting symbol and length value.

The granularity of SBFD active time resource can be resource type within a slot for a set of slots. In one case, gNB can indicate SBFD is enabled in all DL symbols of slot n, DL and F symbols in slot n+1, etc. In another method, the granularity of SBFD active time resource can be set of slots. In another case, gNB indicating SBFD is enabled in slot n, not enabled in slot n+1, etc. The indication can be using bit map. In yet another case, gNB indicate a bit map 110001 in slot n, then SBFD is enabled in slot n+1, slot n+2 and slot n+6.

The indication of active time resource can be using at least one of RRC, MAC-CE and DCI. A set of time resource patterns will be configured using RRC and one will be selected by DCI or MAC-CE. The time resource pattern consists of multiple SBFD active time resources.

The UE should be indicated information about subband so that it can adapt the configured operation at least in the portion of BWP overlapping with the subband. For example, the type 2 UE can skip any operation scheduled within portion of BWP overlapping with the subband. The subband configured for SBFD operation can overlap either partially or fully with the BWP of the UE. FIG. 3 illustrates a scenario in which subband overlaps partially with BWP of the UE. The information about subband comprises starting frequency location and bandwidth of subband. The information can be given as cell-specific, UE-specific or group of UEs specific way.

The granularity of indication can be in terms of one of resource blocks and resource block groups. For example, the bandwidth of the subband is indicated in terms of number of RBs. The starting frequency location can be indicated in terms of an offset from a reference point. In one method, the reference point can be an RB in the common resource grid. For example, the number of RBs between starting RB of the common resource block and starting RB of the subband is indicated to the UE. In another method, the reference point can be the set of frequency resources configured to the UE for monitoring control information, such as CORESET0. In yet another method, the reference point can be the starting location of the BWP configured to the UE. For example, the number of RBs between starting RB of the active BWP and starting RB of the subband is indicated to the UE.

In one implementation, multiple starting frequency locations can be provided using semi-static signaling. The multiple starting frequency locations may be provided in cell specific signal and downselected using UE specific/group UE specific signaling. Further down selection can happen using dynamic signal e.g., DCI. The multiple starting frequency locations may also be provided in semi-static cell specific signal or UE specific or group UE specific signaling and downselected using dynamic signal e.g., DCI.

In one implementation, multiple bandwidths of the subband can be provided using semi-static signaling. Multiple bandwidths may be provided in cell specific signal and downselected using UE specific/group UE specific signaling. Further downselection can happen using dynamic signal e.g., DCI. Multiple bandwidths may also be provided in semi-static cell specific signal or UE specific or group UE specific signaling and downselected using dynamic signal e.g., DCI.

In one implementation, multiple start frequency-bandwidth combinations can be provided in semi-static signaling. The multiple start frequency-bandwidth combinations may be provided in cell specific signal and downselected using UE specific/group UE specific signaling. Further downselection can happen using dynamic signal e.g., DCI. The multiple start frequency-bandwidth combinations may also be provided in semi-static cell specific signal or UE specific or group UE specific signaling and downselected using dynamic signal e.g., DCI.

In case of partial overlap between frequency resources for SBFD and BWP of UE, the gNB can indicate the frequency resources, configured for SBFD operation, overlapping with BWP of UE as subband. Based on subband indication and information about BWP, the UE can determine active portion of the BWP. For example, in FIG. 3, gNB indicates RB3 and RB4 as UL subband to the UE, based on which UE derive RB5 as the active portion of BWP for DL operation.

In another method, the gNB may indicate the frequency resources configured for SBFD operation as subband to the UE. The indication can be with reference to a common reference point, e.g., starting RB of the common resource block or CORESET0. Based on indication of subband and information about BWP, the UE determines the amount of overlap between subband and the BWP. For example, in FIG. 3, the gNB indicate RB1 to RB4 as subband to the UE.

In the above detailed description, reference is made to the accompanying drawings that form a part thereof, and illustrate the best mode presently contemplated for carrying out the invention. However, such description should not be considered as any limitation of scope of the present invention. The structure thus conceived in the present description is susceptible of numerous modifications and variations, all the details may furthermore be replaced with elements having technical equivalence.

We claim:

1. A method of signaling in a cellular network, the method comprising:
receiving, by at least one first node, at least one first configuration and at least one second configuration from at least one second node, wherein the at least one first configuration comprises at least one first resource and type of operation of the at least one first resource, and the at least one second configuration comprises at least one sub-band, type of operation of at least one sub-band and at least one time resource in which the at least one sub-band is active;
determining, by the at least one first node, at least one second resource and type of operation of the at least one second resource for at least one time resource, wherein the at least one second resource and the type of operation of the at least one second resource is determined using at least one of the at least one first configuration and the at least one second configuration; and
performing, by the at least one first node, the type of operation of the at least one second resource in the at least one second resource and the at least one time resource.

2. The method as claimed in claim 1, wherein the type of operation is one of a Downlink (DL) operation and an Uplink (UL) operation.

3. The method as claimed in claim 1, wherein the determining comprises determining at least one first resource comprising at least one time resource.

4. The method as claimed in claim 1, wherein the receiving by the at least one first node is performed based on at least one of a common signaling and a dedicated signaling from at least one second node.

5. The method as claimed in claim 1, wherein at least one of the at least one first configuration and the at least one second configuration is received using at least one of Radio Resource Control (RRC) message, Medium Access Control-Control Element (MAC-CE) message, and at least one Downlink Control Information (DCI).

6. The method as claimed in claim 5, wherein the DCI comprises at least one Slot Format Indicator (SFI).

7. The method as claimed in claim 1, wherein determining the type of operation of the at least one second resource as the type of operation of the at least one first resource when at least one of
the at least one first configuration is received with a priority flag, and
the at least one second configuration is received without priority flag.

8. The method as claimed in claim 1, wherein determining the type of operation of the at least one second resource as the type of operation of at least one sub-band when at least one of
the at least one second configuration is received with a priority flag,
the at least one second configuration is received dynamically,
the at least one second configuration is received using a DCI format dedicated for configuring at least one second configuration, and
the at least one second configuration is received using a DCI format containing at least one Slot Format Indicator (SFI) dedicated for configuring at least one second configuration.

9. The method as claimed in claim 8, wherein the priority flag indicates one of
priority of at least one second configuration over at least one first configuration, and
type of operation of at least one sub-band in which the at least one first node has to operate.

10. The method as claimed in claim 1, wherein determining the type of operation of the at least one second resource comprises one of
determining type of operation of at least one sub-band as downlink (DL) sub-band and determining the type of operation of the at least one second resource as DL, and
determining type of operation of at least one sub-band as uplink (UL) sub-band and determining the type of operation of the at least one second resource as UL.

11. The method as claimed in claim 1, wherein determining the at least one second resource comprises one of
determining a non-overlapping portion of at least one first resource and at least one sub-band as at least one second resource, and
determining an overlapping portion of at least one first resource and at least one sub-band as at least one second resource.

12. The method as claimed in claim 11, wherein determining the non-overlapping portion of at least one first resource and at least one sub-band as at least one second resource comprises one of
determining at least one first operation is reception of at least one Channel State Information-Reference Signal (CSI-RS),
determining type of operation of the at least one first resource as DL and type of operation of at least one sub-band as UL, and
determining type of operation of the at least one first resource as UL and type of operation of at least one sub-band as DL.

13. The method as claimed in claim 11, wherein determining the overlapping portion of the at least one first resource and the at least one sub-band as the at least one second resource comprises one of
determining a type of operation of the at least one first resource as DL and type of operation of at least one sub-band as DL, and
determining a type of operation of the at least one first resource as UL and a type of operation of at least one sub-band as UL.

14. The method as claimed in claim 1, comprising receiving, by the at least one second node, an indication of at least one second resource and type of operation of the at least one second resource.

15. The method as claimed in claim 14, wherein the receiving is using at least one of dedicated signaling and Downlink Control Information (DCI).

16. The method as claimed in claim 1, wherein the at least one time resource comprises at least one of an index, starting time, duration and periodicity.

17. The method as claimed in claim 16, wherein the starting time comprises at least one of slot offset, symbol offset and number of time units.

18. The method as claimed in claim 16, wherein the duration comprises at least one of number of slots, number of symbols and number of time units.

19. The method as claimed in claim 16, wherein the starting time is applied from start of time unit of receiving.

20. The method as claimed in claim 16, wherein the starting time is applied from start of time unit immediately after time unit of receiving.

21. The method as claimed in claim 16, wherein the starting time of at least one second configuration is predefined.

22. The method as claimed in claim 1, wherein receiving is at least one of periodic, semi-persistent, and aperiodic.

23. The method as claimed in claim 1, wherein the receiving comprises
receiving a plurality of second configuration using a Radio Resource Control (RRC) message, and
receiving at least one of Medium Access Control-Control Element (MAC-CE) message and Downlink Control Information (DCI) activating the at least one second configuration.

24. The method as claimed in claim 23, wherein the activating comprises an index of at least one second configuration.

25. The method as claimed in claim 1, further comprising
receiving, by the at least one first node, a deactivation command, and
deactivating, by the at least one first node, the at least one second configuration.

26. The method as claimed in claim 1, wherein the at least one time resource is indicated for a plurality of slots, and wherein the plurality of slots is contiguous and marked by starting slot index and number of slots.

27. The method as claimed in claim 1, wherein the at least one time resource comprises symbol type in a time unit.

28. The method as claimed in claim 27, wherein the symbol type is at least one of DL symbols, UL symbols and flexible symbols.

29. The method as claimed in claim 26, wherein the at least one time resource is indicated using a bitmap.

30. The method as claimed in claim 25, wherein the receiving is one of cell-specific signal, node-specific signal, and group of nodes specific signal.

31. The method as claimed in claim 1, wherein the at least one sub-band comprises a starting frequency location and a bandwidth of the at least one sub-band.

32. The method as claimed in claim 31, wherein the bandwidth of the at least one sub-band is indicated by a number of Resource Block (RB).

33. The method as claimed in claim 31, wherein the starting frequency location is indicated by an offset from a reference point, and wherein the reference point is one of
an RB in a common resource grid,
starting frequency resource from a plurality of frequency resources configured to the at least one second node for monitoring control information, and
starting frequency resource of the BWP configured to the at least one second node.

34. The method as claimed in claim 1, comprising determining, by the at least one first node, the active BWP based on the at least one first configuration and the at least one second configuration.

35. The method as claimed in claim 33, wherein the determining comprises
determining type of operation of the at least one first resource same as a type of operation of the at least one sub-band, and
determining an overlapping portion of the at least one first resource and the at least one sub-band as active BWP.

36. The method as claimed in claim 33, wherein the determining comprises
determining a type of operation of the at least one first resource different from type of operation of the at least one sub-band, and
determining an non-overlapping portion of at least one first resource and the at least one sub-band as active BWP.

37. A method of signaling in a cellular network, the method comprising:
signaling, by at least one first node, at least one first configuration comprising at least one sub-band, type of operation of the at least one sub-band, and at least one time resource in which the at least one sub-band is active, wherein the type of operation of at least one sub-band comprises one of DL sub-band and UL sub-band; and
performing, by the at least one first node, in the at least one time resource
at least one DL operation in at least one first frequency resource in DL sub-band, and
at least one UL operation in at least one second frequency resource in UL sub-band.

38. The method as claimed in claim 37, wherein the signaling comprises determining at least one sub-band and at least one time resource in which the at least one sub-band is active.

39. The method as claimed in claim 37, wherein the at least one first configuration comprises at least one of Time Division Duplexing (TDD) configuration and Bandwidth Part (BWP) configuration.

40. The method as claimed in claim 37, wherein the signaling is done as one of common signaling and dedicated signaling.

41. The method as claimed in claim 37, wherein the signaling uses at least one of Radio Resource Control (RRC) message, MAC-CE message, and downlink control information (DCI).

42. The method as claimed in claim 41, wherein DCI format comprises a Slot Format Indicator (SFI).

43. The method as claimed in claim 37, comprising performing at least one of
scheduling, by the at least one first node, at least one DL operation to at least one second node in at least one time resource and at least one first frequency resource, and
scheduling, by the at least one first node, at least one UL operation to at least one third node in at least one time resource and at least one second frequency resource.

44. The method as claimed in claim 43, wherein the scheduling comprises a priority flag.

45. The method as claimed in claim 43, wherein the scheduling is done using Downlink Control Information (DCI).

46. The method as claimed in claim 37, wherein at least one first configuration comprises a priority flag.

47. The method as claimed in claim 46, wherein the priority flag indicates one of
a priority of at least one first configuration over other configurations,
a priority of a subband from the at least one subband, and
a subband from at least one sub-band in which the at least one second node has to operate.

48. The method as claimed in claim 37, wherein the signaling is one of periodic, semi-persistent and aperiodic.

49. The method as claimed in claim 37, wherein the at least one time resource comprises at least one of an index, starting time, duration, and periodicity.

50. The method as claimed in claim 49, wherein the starting time comprises at least one of slot offset, symbol offset and number of time units.

51. The method as claimed in claim 49, wherein the duration comprises at least one of number of slots, number of symbols, and number of time units.

52. The method as claimed in claim 49, wherein the starting time is applied from start of a time unit, and wherein the time unit is one of
time unit of signaling at least one first configuration, and
time unit immediately after signaling at least one first configuration.

53. The method as claimed in claim 37, wherein the signaling comprises
signaling a plurality of at least one first configurations, and
activating at least one first configuration from the plurality of at least one first configurations.

54. The method as claimed in claim 53, wherein the activating comprises indicating an index of at least one first configuration.

55. The method as claimed in claim 37, comprising signaling a deactivation command and deactivating the at least one first configuration.

56. The method as claimed in claim 37, wherein the at least one time resource comprises a plurality of time units in a time duration.

57. The method as claimed in claim 56, wherein the plurality of time units is contiguous and marked by starting slot index and number of slots.

58. The method as claimed in claim 37, wherein the at least one time resource comprises symbol type within a time unit.

59. The method as claimed in claim 58, wherein the symbol type is at least one of DL symbols, UL symbols, and flexible symbols.

60. The method as claimed in claim 37, wherein the at least one time resource is indicated using a bitmap.

61. The method as claimed in claim 37, wherein the at least one sub-band comprises a starting frequency location and a bandwidth of the at least one sub-band.

62. The method as claimed in claim 61, wherein a bandwidth of the at least one sub-band is indicated by number of Resource Block (RB).

63. The method as claimed in claim 61, wherein the starting frequency location is indicated by an offset from a reference point, and wherein the reference point is one of
a RB in a common resource grid,
starting frequency resource from a plurality of frequency resources configured to the at least one second node for monitoring control information, and
starting frequency resource of the BWP configured to the at least one second node.

64. The method as claimed in claim 37, wherein the signaling is one of cell-specific signal, node-specific signal, and group of nodes specific signal.
